(19) United States
(12) Patent Application Publication
(10) Pub. No.: US 2006/0270585 A1
(43) Pub. Date: Nov. 30, 2006

(54) Cleaning wipe comprising perfume microcapsules, a kit and a method of use thereof

(75) Inventors: Glenn Thomas Jordan IV, Indian Springs, OH (US); Patricia Ann Blondin, Cincinnati, OH (US); Zaiyou Liu, West Chester, OH (US); Kristin Marie Finley, Milford, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/442,867

(22) Filed: May 30, 2006

Related U.S. Application Data
(60) Provisional application No. 60/685,932, filed on May 31, 2005.

(51) Int. Cl. C11D 17/00

(52) U.S. Cl. 510/439

(57) ABSTRACT

The present invention relates to a cleaning wipe suitable for cleaning a surface comprising a cleaning substrate, and microcapsules comprising a perfume composition. At least 40% of the perfume raw materials in the perfume composition have a boiling point of 250 ° C. or less, a Kovats Index value of 1450 or less, or a combination thereof. The present invention also relates to (1) a cleaning kit for cleaning a surface comprising the cleaning wipe, and a cleaning implement comprising a handle, and (2) to a method of cleaning a surface comprising the step of contacting the surface with the cleaning wipe.

### CROSS REFERENCE TO RELATED APPLICATION

This application claims the benefit of U.S. Provisional Application No. 60/685,932, filed on May 31, 2005.

### FIELD OF THE INVENTION

The present invention relates to a cleaning wipe suitable for cleaning hard surfaces comprising a micro-encapsulated perfume composition, cleaning kits comprising the cleaning wipe, and methods of use thereof.

### BACKGROUND OF THE INVENTION

Cleaning wipes comprising encapsulated perfume are well known in the art. For example, WO 01/73188 (Givaudan) describes a disposable cleaning cloth having microcapsules containing an odoriferous liquid active ingredient, fixed to its surface. The cloth provides a long-lasting active ingredient release in the air, and burst-like active transfer of perfume when a surface is wiped. EP-A-1410753 (3M) describes an abrasive cleaning article comprising a three-dimensional nonwoven web of fibers, and 10-250 μm microcapsules containing an aromatizing substance bonded to the web by a resin adhesive. GB 1374272 (Johnson & Johnson) describes a disposable cleaning pad comprising an absorbent filler and rupturable perfume capsules. The capsules can have a water-soluble shell to release the perfume upon dissolution. WO 00/27271 (The Procter & Gamble Company) describes cleaning pads containing moisture-activated encapsulated perfume particles. The particles are made of cyclodextrin or of a polysaccharide/polyhydroxy cellular matrix, and are preferably incorporated in the absorbent layer of the pad.

One disadvantage of the cleaning wipes of the prior art is that they do not yet provide optimum perfume release from the microcapsules during use. This is because the perfume composition contained in the microcapsules is not designed to be effectively released from the microcapsules. It has now been found that optimum perfume release can be achieved when the perfume composition is specifically developed for use in the microcapsules.

Accordingly, it is an object of the present invention to provide a cleaning wipe with improved perfume release from the microcapsules during use. It is further an object of the present invention to provide a cleaning wipe which provides both an immediate odor intensity benefit (i.e. bloom) as well as a long-lasting odor benefit (i.e. longevity). Bloom is typically experienced during use of the cleaning wipe, and up to 1 to 15 minutes after usage, while the long-lasting odor benefit is typically experienced up to 2 to 5 hours after use.

### SUMMARY OF THE INVENTION

According to a first aspect, the present invention relates to a cleaning wipe suitable for cleaning a surface comprising:
(a) a cleaning substrate; and
(b) microcapsules comprising a perfume composition;
   characterized in that at least 40% of the perfume raw materials in said perfume composition have a boiling point of 250° C. or less, a Kovats Index value of 1450 or less, or a combination thereof.

According to a second aspect, the present invention relates to a cleaning kit suitable for cleaning a surface, comprising:
(a) a cleaning implement comprising a handle; and
(b) a cleaning wipe of the present invention.

According to a third aspect, the present invention relates to a method of cleaning a surface comprising the step of contacting said surface with a cleaning wipe.

According to a fourth aspect, the present invention relates to microcapsules for use in a cleaning wipe, said microcapsules comprising a perfume composition, characterized in that at least 40% of the perfume raw materials in said perfume composition have a boiling point of 250° C. or less, a Kovats Index value of 1450 or less, or a combination thereof.

### BRIEF DESCRIPTION OF THE DRAWINGS

FIG. 1 shows a perspective view of a preferred cleaning implement for use with a cleaning wipe of the present invention.

### DETAILED DESCRIPTION

I. Cleaning Wipe

The cleaning wipe according to the present invention comprises a cleaning substrate, and microcapsules comprising a perfume composition. The cleaning wipe of the present invention is preferably disposable. By the term disposable it is meant that the wipe is designed for use for a single cleaning task, or a small number (typically less than 3) of cleaning tasks only, and is then preferably discarded. The cleaning wipe of the present invention can be used for example for dry dusting of hard surfaces, but is preferably used in combination with a cleaning composition for wet cleaning of hard surfaces, such as floors, sinks, bathtubs, shower walls, glass, kitchen surfaces, cars and the like.

The cleaning wipe according to the present invention may further comprise one or more additional attachment means for attaching the wipe to a cleaning implement. Suitable attachment means are, but not limited to, one or more protrusions in the wipe (which would correspond to pin(s) on the mop head), hook or loop fasteners, adhesives, straps, or any other suitable attachment means known in the art, or any combinations thereof. This also includes attachment means, of which part of the attachment means is located on the wipe, and a corresponding part of the attachment means is located on the cleaning implement's mop head, such as e.g. press-stud systems.

In a preferred embodiment, the additional attachment means is an attachment layer that allows the wipe to be connected to a cleaning implement's mop head. The attachment layer will be necessary in those embodiments where the cleaning substrate is not suitable for attaching the wipe to the mop head of the implement. The attachment layer may also function as a means to reduce or prevent fluid flow through the upper surface of the cleaning substrate, and may further provide enhanced integrity of the substrate. The attachment layer may consist of a mono-layer or a multi-layer structure, so long as it meets the above requirements. It is preferred that a laminated structure comprising, e.g., a meltblown film and fibrous, nonwoven structure be utilized. In a preferred embodiment, the attachment layer is a spun-bonded polypropylene. The attachment layer is attached to the upper surface of the cleaning substrate, and has a surface equal to, or larger than the cleaning substrate's upper surface.

The cleaning wipe will now be explained in more detail.

II. Cleaning Substrate

The cleaning wipe according to the present invention comprises a cleaning substrate. To be clear, the definition of cleaning substrate does not include an attachment means or attachment layer. The cleaning substrate preferably comprises nonwoven fibers or paper. The term nonwoven is to be defined according to the commonly known definition provided by the “Nonwoven Fabrics Handbook” published by the Association of the Nonwoven Fabric Industry. A paper substrate is defined by EDANA (note 1 of ISO 9092-EN 29092) as a substrate of which more than 50% by mass of its fibrous content is made up of fibers (excluding chemically digested vegetable fibers) with a length to diameter ratio of greater than 300, and more preferably also has density of less than 0.040 g/cm³. To be clear, the definitions of both nonwoven and paper substrates do not include woven fabric or cloth or sponge.

The cleaning substrate may comprise fibers that are naturally occurring (modified or unmodified), as well as synthetically made fibers. Natural fibers include all those, which are naturally available without being modified, regenerated or produced by man and are generated from plants, animals, insects or by-products of plants, animals and insects. Examples of suitable unmodified/modified naturally occurring fibers include cotton, Esparto grass, bagasse, kemp, flax, silk, wool, wood pulp, chemically modified wood pulp, jute, ethyl cellulose, cellulose acetate, and combinations thereof. As used herein, “synthetic” means that the materials are obtained primarily from various man-made materials or from natural materials that have been further altered. Nonlimiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers and combinations thereof. Examples of suitable synthetic materials include acrylics such as acrilan, creslan, and the acrylonitrile-based fiber, orlon; cellulose ester fibers such as cellulose acetate, arnel, and acele; polyamides such as nylons (e.g., nylon 6, nylon 66, nylon 610, and the like); polyesters such as fortrel, kodel, and the polyethylene terephthalate fiber, polybutylene terephalate fiber, dacron; polyolefins such as polypropylene, polyethylene; polyvinyl acetate fibers and combinations thereof. These and other suitable fibers and the nonwovens prepared therefrom are generally described in Riedel, “Nonwoven Bonding Methods and Materials,” Nonwoven World (1987); The Encyclopedia Americana, vol. 11, pp. 147-153, and vol. 26, pp. 566-581 (1984). Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), and combinations thereof. Such bicomponent fibers may have a core-sheath configuration or a side-by-side configuration. Suitable bicomponent fibers for use in the present invention can include sheath/core fibers having the following polymer combinations: polyethylene/poly-propylene, polyethylvinyl acetate/polypropylene, polyethylene/polyester, polypropylene/polyester, copolyester/polyester, and the like. Particularly suitable bicomponent thermoplastic fibers for use herein are those having a polypropylene or polyester core, and a lower melting copolyester, polyethylvinyl acetate or polyethylene sheath (e.g., those available from Danaklon a/s and Chisso Corp.). These bicomponent fibers can be concentric or eccentric. As used herein, the terms “concentric” and “eccentric” refer to whether the sheath has a thickness that is even, or uneven, through the cross-sectional area of the bicomponent fiber. Eccentric bicomponent fibers can be desirable in providing more compressive strength at lower fiber thicknesses. Preferred bicomponent fibers comprise a copolyolefin bicomponent fiber comprising less than about 81% polyethylene terephthalate core and a less than about 51% copolyolefin sheath. The amount of bicomponent fibers will preferably vary according to the density of the material in which it is used.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining substrate. In the present invention the nonwoven substrate can be prepared by a variety of processes including, but not limited to, air-entanglement, hydro-entanglement, thermal bonding, carding, needle-punching, or any other process known in the art, and combinations of these processes. However, a nonwoven substrate may also be described as a thermoplastic formed film.

The cleaning substrate is preferably partially or fully permeable to water and an aqueous hard surface cleaning composition.

The cleaning substrate of the cleaning wipe can be mono-layered, but is preferably multi-layered and comprises an upper and a lower layer. The layers are bonded together to form a unitary structure. The layers can be bonded in a variety of ways including, but not limited to, adhesive bonding, thermal bonding, ultra sonic bonding, and the like. The layers can be assembled to form a cleaning substrate either by hand or by a conventional line converting process known in the art.

According to a preferred embodiment of the present invention, the cleaning substrate comprises an absorbent layer, and optionally a scrubbing layer. This cleaning substrate is particularly designed for cleaning floors or other hard surfaces, and is preferably used in combination with an aqueous cleaning composition suitable for cleaning floors.

The absorbent layer comprises any material capable of absorbing and retaining fluid during use. It is preferred that the absorbent layer is sandwiched between an upper layer and a lower layer. Typically, the absorbent layer comprises nonwoven fibrous material. The absorbent layer can comprise solely naturally occurring fibers, solely synthetic fibers, or any compatible combination of naturally occurring and synthetic fibers. The fibers useful herein can be hydrophilic, hydrophobic or can be a combination of both hydrophilic and hydrophobic fibers. As used herein, the term “hydrophilic” is used to refer to surfaces that are wettable by is aqueous fluids deposited thereon. Hydrophilicity and wettability are typically defined in terms of contact angle and the surface tension of the fluids and solid surfaces involved. This is discussed in detail in the American Chemical Society publication entitled “Contact Angle, Wettability and Adhesion”, edited by Robert F. Gould (Copyright 1964). A surface is said to be wetted by a fluid (i.e., hydrophilic) when either the contact angle between the fluid and the surface is less than 90°, or when the fluid tends to spread spontaneously across the surface, both conditions normally co-existing. Conversely, a surface is considered to be “hydrophobic” if the contact angle is greater than 90° and the fluid does not spread spontaneously across the surface. The particular selection of hydrophilic or hydrophobic fibers will depend upon the other materials included in the cleaning substrate, for instance in different absorbent layers. That is, the nature of the fibers will be such that the cleaning substrate exhibits the necessary fluid delay and overall fluid absorbency. Suitable hydrophilic fibers for use in the present invention include cellulosic fibers, modified cellulosic fibers, rayon, polyester fibers such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene or polypropylene, polyacrylics, polyamides, polystyrenes, polyurethanes and the like. Suitable wood pulp fibers can be obtained from well-known chemical processes such as the Kraft and sulfite processes. It is especially preferred to derive these wood pulp fibers from southern soft woods due to their premium absorbency characteristics. These wood pulp fibers can also be obtained from mechanical processes, such as ground wood, refiner mechanical, thermomechanical, chemimechanical, and chemi-thermomechanical pulp processes. Recycled or secondary wood pulp fibers, as well as bleached and unbleached wood pulp fibers, can be used. Another type of hydrophilic fiber for use in the absorbent layer is chemically stiffened cellulosic fibers. As used herein, the term “chemically stiffened cellulosic fibers” means cellulosic fibers that have been stiffened by chemical means to increase the stiffness of the fibers under both dry and aqueous conditions. Such means can include the addition of a chemical stiffening agent that, for example, coats and/or impregnates the fibers. Such means can also include the stiffening of the fibers by altering the chemical structure, e.g., by crosslinking polymer chains.

The absorbent layer preferably has a basis weight of from 60 g/m² to 300 g/m², more preferably from 80 g/m² to 200 g/m², most preferably from 90 g/m² to 160 g/m². It is preferably composed of from 70% to 90% wood pulp fibers or other cellulosic materials, 1% to 30% binders, and 1% to 30% of bicomponent fibers.

Where the cleaning substrate comprises an upper layer and a lower layer, they too may comprise any of the above absorbent materials, or may be non-absorbent but fluid pervious in nature. If the upper and/or lower layer is absorbent, it will typically have lower absorbency than the absorbent layer. The upper layer and the lower layer may comprise separate layer materials, or may be portions of the same layer material, for instance which is wrapped around the absorbent layer. Furthermore, the upper layer and lower layer may each independently comprise a monolayer or multi-layer structure, and additional components may be included between the upper and/or lower layer and the absorbent layer.

The optional, but preferred, scrubbing layer is the portion of the cleaning substrate that contacts the soiled surface during cleaning, i.e. is the lower layer of the cleaning substrate. As such, materials useful as the scrubbing layer must be sufficiently durable that the layer will retain its integrity during the cleaning process. In addition, when the cleaning substrate is used in combination with a solution, the scrubbing layer must be capable of absorbing liquids and soils, and relinquishing those liquids and soils to the absorbent layer. This will ensure that the scrubbing layer will continually be able to remove additional material from the surface being cleaned. Whether the implement is used with a cleaning solution (i.e., in the wet state) or without cleaning solution (i.e., in the dry state), the scrubbing layer will, in addition to removing particulate matter, facilitate other functions, such as polishing, dusting, and buffing the surface being cleaned. The scrubbing layer can be a monolayer, or a multi-layer structure one or more of whose layers may be slitted to faciliate the scrubbing of the soiled surface and the uptake of particulate matter. This scrubbing layer, as it passes over the soiled surface, interacts with the soil (and cleaning solution when used), loosening and emulsifying tough soils and permitting them to pass freely into the absorbent layer of the substrate. The scrubbing layer preferably contains openings (e.g., slits) that provide an easy avenue for larger particulate soil to move freely in and become entrapped within the absorbent layer of the wipe. Low-density structures are preferred for use as the scrubbing layer, to facilitate transport of particulate matter to the wipe's absorbent layer.

A wide range of materials is suitable for use in the scrubbing layer, for instance as disclosed in WO-A-0027271. In particular, the scrubbing layer may comprise woven and nonwoven materials; polymeric materials such as apertured formed thermoplastic films, apertured plastic films, and hydroformed thermoplastic films; porous foams; reticulated foams; reticulated thermoplastic films; and thermoplastic scrims. Suitable woven and nonwoven materials can comprise natural fibers (e.g., wood or cotton fibers), synthetic fibers such as polyolefins (e.g., polyethylene, particularly high density polyethylene, and polypropylene), polyesters (e.g., polyethylene terephthalate), polyimides (e.g., nylon) and synthetic cellulosics (e.g., RAYON®), polystyrene, and blends and copolymers thereof, and combinations of natural and synthetic fibers.

The scrubbing layer may comprise, at least in part, an apertured-formed film. Apertured-formed films are preferred for the liquid pervious scrubbing layer because they are pervious to aqueous cleaning liquids containing soils, including dissolved and undissolved particulate matter, yet are non-absorbent and have a reduced tendency to allow liquids to pass back through and rewet the surface being cleaned. Thus, the surface of the formed film which is in contact with the surface being cleaned remains dry, thereby reducing filming and streaking of the surface being cleaned and permitting the surface to be wiped substantially dry. An apertured formed film having tapered or funnel-shaped apertures, meaning that the diameter at the lower end of the aperture is greater than the diameter at the upper end of the aperture, actually exhibits a suctioning effect as the cleaning substrate is moved across the surface being cleaned. This aids in moving liquid from the surface being cleaned to other layers of the cleaning substrate, such as the absorbent layer(s). In addition, tapered or funnel-shaped apertures have an even greater tendency to prevent liquids from passing back through the scrubbing layer to the surface being cleaned once they have been transferred to other layers, such as the absorbent layer(s). Apertured-formed films having tapered or funnel-shaped apertures are thus preferred. Suitable apertured-formed films are described in U.S. Pat. No. 3,929,135, entitled “Absorptive Structures Having Tapered Capillaries”, which issued to Thompson on Dec. 30, 1975; U.S. Pat. No. 4,324,246 entitled “Disposable Absorbent Article Having A Stain Resistant Topsheet”, which issued to Mullane et al. on Apr. 13, 1982; U.S. Pat. No. 4,342,314 entitled “Resilient Plastic Web Exhibiting Fiber-Like Properties”, which issued to Radel at al. on Aug. 3, 1982; U.S. Pat. No. 4,463,045 entitled “Macroscopically Expanded Three-Dimensional Plastic Web Exhibiting Non-Glossy Visible Surface and Cloth-Like Tactile Impression”, which issued to Ahr et al. on Jul. 31, 1984; and U.S. Pat. No. 5,006,394 entitled “Multilayer Polymeric Film” issued to Baird on Apr. 9, 1991. The preferred liquid pervious scrubbing layer for the present invention is the apertured-formed film described in one or more of the above patents and marketed on sanitary napkins by The Procter & Gamble Company of Cincinnati, Ohio as DRI-WEAVE®.

Although a hydrophilic apertured-formed film can be used as a liquid pervious scrubbing layer of a cleaning substrate, in the context of hard surface cleaning, a hydrophobic apertured-formed film is preferred since it will have a reduced tendency to allow liquids to pass back through the scrubbing layer and onto the surface being cleaned. This results in improved cleaning performance in terms of filming and streaking, lower soil residue, and faster drying time of the surface being cleaned, all of which are very important aspects of hard surface cleaning. The liquid pervious scrubbing layer of the present cleaning substrate is thus preferably a hydrophobic apertured-formed film, at least in part. It is also recognized that the scrubbing layer can be comprised of more than one type of material.

In a preferred embodiment, the liquid pervious scrubbing layer is a macroscopically expanded three-dimensional plastic web, preferably having protruberances, or surface aberrations, on the lower surface of the scrubbing layer which, in use, contacts the hard surface being cleaned. As used herein, the term “macroscopically expanded”, when used to describe three-dimensional plastic webs, ribbons, and films, refers to webs, ribbons, and films which have been caused to conform to the surface of a three-dimensional forming structure so that both surfaces thereof exhibit the three-dimensional pattern of said forming structure, said pattern being readily visible to the naked eye when the perpendicular distance between the viewer's eye and the plane of the web is about 12 inches (about 30 cm). Such macroscopically expanded webs, ribbons and films are typically caused to conform to the surface of said forming structures by embossing, i.e., when the forming structure exhibits a pattern comprised primarily of male projections, by debossing, i.e., when the forming structure exhibits a pattern comprised primarily of female capillary networks, or by extrusion of a resinous melt directly onto the surface of a forming structure of either type. By way of contrast, the term “planar”, when utilized herein to describe plastic webs, ribbons and films, refers to the overall condition of the web, ribbon or film when viewed by the naked eye on a macroscopic scale. In this context, “planar” webs, ribbons and films can include webs, ribbons and films having fine scale surface aberrations on one or both sides, said surface aberrations not being readily visible to the naked eye when the perpendicular distance between the viewer's eye and the plane of the web is about 12 inches (about 30 cm) or greater. Surface aberrations are created on a plastic web by photoetching techniques well known in the art. A detailed description of such a web and a process for making it is disclosed by Ahr et al., U.S. Pat. No. 4,463,045, issued Jul. 31, 1984 and assigned to The Procter & Gamble Company, which is hereby incorporated by reference. Ahr et al. disclose a macroscopically expanded three-dimensional web having surface aberrations for use as a topsheet in diapers, sanitary napkins, incontinence devices, and the like. Ahr at al. prefer a web having surface aberrations because it imparts a non-glossy appearance to the web and improves the tactile impression of the web by making it feel more cloth-like to the wearer of the diaper, sanitary napkin, etc. However, in the context of hard surface cleaning, appearance and tactile impression of a cleaning substrate are of lesser importance. A liquid pervious scrubbing layer comprising a macroscopically expanded three-dimensional web having surface aberrations results in improved performance of the scrubbing layer. The surface aberrations provide a more abrasive surface, which correlates to better cleaning performance. The surface aberrations, in combination with tapered or funnel-shaped apertures, provide enhanced cleaning, absorbency, and rewet characteristics of the cleaning substrate. The liquid pervious scrubbing layer thus preferably comprises an apertured-formed film comprising a macroscopically expanded three-dimensional plastic web having tapered or funnel-shaped apertures and/or surface aberrations. A three-dimensional scrubbing layer is especially preferable for improving a cleaning substrate's ability to pick-up particulate matter.

III. Perfume

The cleaning wipe according to the present invention comprises an encapsulated perfume composition. The term “perfume composition” is used to mean a composition containing at least 0.1% by weight of one or more perfume raw materials. As is well known, a perfume normally consists of a mixture of a number of perfume raw materials, each of which has an odor or fragrance. The number of perfume raw materials in a perfume is typically 10 or more. The range of perfume raw materials used in perfumery is very wide; the materials come from a variety of chemical classes, but in general are water insoluble oils.

Perfume raw materials can be characterized by their boiling point (B.P.) and their Kovats Index values. The boiling points of many perfume ingredients are reported in, e.g., “Perfume and Flavor Chemicals (Aroma Chemicals),” Steffen Arctander, published by the author, 1969. The Kovats Retention Index system is an accurate method for reporting gas chromatographic (GC) data for interlaboratory substance identification, and is explained in e.g. “Chromatographic Retention Indices”, V. Pacakova & L. Feltl, published by Ellis Horwood, 1992, ISBN 0-13-772328-8). It is used for eliminating the effects of instrument parameters on the correlations between the retention time and the chemical identification by GC. The Kovats Index (KI or I) value of many perfume ingredients has been reported. The Kovats Index value of an unknown substance can be calculated from the following equation:

$$KI = 100 [ n + ( N - n ) \frac{log {t}_{x}^{′} - log {t}_{n}^{′}}{log {t}_{N}^{′} - log {t}_{n}^{′}} ]$$

where n is the number of carbon atoms in the smaller alkane
N is the number of carbon atoms in the larger alkane
t′(n) is the adjusted retention time of the smaller alkane
t′(N) is the adjusted retention time of the larger alkane

It is noted that this equation applies to a particular non-polar stationary phase in the GC column. Based on the above equation, the Kovats Index for a linear alkane is equal to 100 times the number of carbon atoms. For example, octane has a KI value of 800, decane has a KI value of 1000, octanol has a KI value of 826, hexadecanol would have a KI value of 1626. The KI values used herein are determined using polydimethylsiloxane as the non-polar stationary phase in the column (referred to as a “DB-5 column”).

In order to provide a cleaning wipe having the desired perfume release profile, it has been found that at least 40%, by weight, of the perfume raw materials in the encapsulated perfume composition must have a boiling point of 250° C. or less, a Kovats Index of 1450 or less, or a combination thereof. Preferably, at least 50%, by weight, of the perfume raw materials in the encapsulated perfume composition have a boiling point of 250° C. or less, a Kovats Index of 1450 or less, or a combination thereof. Preferably 40% to 90%, more preferably 50% to 80% and most preferably 70% to 80%, by weight, of the perfume raw materials in the encapsulated perfume composition have a boiling point of 250° C. or less, a Kovats Index of 1450 or less, or a combination thereof. A preferred range for the boiling point is from 100° C. to 250° C. The Kovats Index is preferably from 800 to 1450, more preferably from 900 to 1400 and most preferably from 1000 to 1350.

Perfume raw materials having a boiling point of 250° C. or less or a Kovats Index of 1450 or less, are volatile and therefore are easily, and gradually, released from the microcapsules (contrary to perfume raw materials having a higher boiling point or Kovats Index value) when these rupture or when they dissolve upon contact with an aqueous solution. Perfume compositions comprising the above specified amounts of such perfume raw materials therefore provide both blooming and longevity benefits when incorporated into microcapsules and used in the cleaning wipes of the present invention.

Nonlimiting examples of perfume raw materials suitable for use herein include, but are not limited to, hexanal, ethyl butyrate, ethyl-2-methyl butyrate, cis-3-hexenol, iso-amyl acetate peak, amyl acetate, prenyl acetate, manzanate, alpha-pinene, camphene, benzaldehyde, beta-pinene, dimetol, myrcene, cis-3-hexenyl acetate, octanal, hexyl acetate, 1,4-cineole, p-cymene, phenyl acetaldehyde, melonal (2,6-dimethyl-2-heptenal), trimethyl cyclohexanol, diethyl malonate, gamma-terpinene, dihydro myrcenol, allyl caproate, ligustral, alpha-terpinolene, tetra hydro linalool, tetra hydro myrcenol, linalool, methyl benzoate, liffarome, nonanal, leaf acetal, rose oxide (cis-Isomer), myrcenol, phenyl ethyl alcohol, fenchyl alcohol, dihydro linalool, iso-cyclo citral, 1-terpineol, dimethyl benzyl carbinol, citronellal, fructone, methyl pamplemousse, 2-nonenal (iris aldehyde), camphor, 2,6-nonadienol, benzyl acetate, oxane, iso-borneol, allyl heptoate, iso-menthone, methyl heptine carbonate, ethyl linalool, menthol, terpinen-4ol methyl phenyl carbinyl acetate, alpha-terpineol, ethyl maltol, methyl chavicol, decyl aldehyde, methyl salicylate, linalyl formate, phenyl acetaldehyde dimethyl acetal, citronellol, tetra hydro linalyl acetate, citronellyl nitrile, geranyl nitrile, nerol, allyl amyl glycolate, linalyl acetate, geraniol, benzyl acetone, carvone, phenyl ethyl acetate, undecavertol, benzyl propionate, anisic aldehyde, methyl phenyl carbinyl propionate, hydroxycitronellal, thymol, anethole, methyl octine carbonate, indole, iso-bornyl acetate, undecyl aldehyde, verdox, cinnamic alcohol, nonyl acetate, dimethyl benzyl carbinyl acetate, linalyl propionate, heliotropine, citronellyl acetate, buccoxime, methyl anthranilate, methyl lavender ketone, neryl acetate, terpinyl acetate, methyl nonyl acetaldehde, eugenol, gamma-nonalactone, geranyl acetate, delta-damascone, methyl cinnamnate, methyl eugenol, alpha-damascone, damascenone, vanillin, lauric aldehyde, citronellyl oxyacetaldehyde, cis-jasmone, diphenyl oxide, calone 1951, dimethyl anthranilate, beta-damascone, flor acetate, florhydral, alpha-ionone.

It is further preferred that the perfume composition provides citrus, lemon or floral freshness. A citrus, lemon, or floral scent typically provides an overall impression of cleanness and freshness, and is considered important by consumers. In order to release a citrus or lemon scent from the microcapsules, the perfume composition preferably comprises at least one perfume raw material selected from the group of citronellal, trans-4-decenal, decyl aldehyde, dihydro myrcenol, geranyl nitrile, iso cyclo citral, lemonile, methyl dihydro jasmonate, and methyl nonyl acetaldehyde. Floral freshness can be provided by a perfume composition comprising at least one perfume raw material selected from the group of citronellol, bourgenol, cis jasmine, linalool, methyl salicylate, and benzyl acetate.

Preferably an amount of 10 mg to 500 mg, more preferably an amount of 20 mg to 200 mg, even more preferred an amount of 40 mg to 100 mg, and most preferably an amount of 50 mg to 60 mg of the perfume composition is contained in the microcapsules, on a single wipe.

IV. Microcapsules

Encapsulation of perfume or other materials in small capsules (or microcapsules), typically having a diameter less than 1000 microns, is well known. Various types of microcapsules for encapsulating perfumes exist, e.g. polymeric particles, cyclodextrin/perfume inclusion complexes, polysaccharide cellular matrices. One type of capsule, referred to as a wall or shell capsule, is preferred in the present invention. Wall or shell capsules comprise a generally spherical hollow shell of insoluble material, typically polymer material, within which the active material of perfume is contained.

The shell capsules may be prepared using a range of conventional methods known to those skilled in the art for making shell capsules such as coacervation, interfacial polymerization and poly-condensation. The process of coacervation typically involves encapsulation of a generally water-insoluble material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration. Coacervation techniques are described, e.g. in U.S. Pat. No. 2,800,458, U.S. Pat. No. 2,800,457, GB929403, EP385534 and EP376385. It is recognized however that many variations with regard to materials and process steps are possible.

Interfacial polymerization produces encapsulated shells from the reaction of at least one oil-soluble wall forming material present in the oil phase with at least one water-soluble wall forming material present in the aqueous phase. A polymerization reaction between the two wall-forming materials occurs resulting in the formation of covalent bonds at the interface of the oil and aqueous phases to form the capsule wall. An example of a shell capsule produced by this method is a polyurethane capsule.

Polycondensation involves forming a dispersion or emulsion of water-insoluble material e.g. perfume in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed water-insoluble material fill to produce a coherent film and the desired micro-capsules. Polycondensation techniques are described, e.g. in U.S. Pat. No.3,516,941, U.S. Pat. No.4,520,142, U.S. Pat. No.4,528,226, U.S. Pat. No.4,681,806, U.S. Pat. No. 4,145,184 and GB2073132 and WO 99/17871. It is recognized however that many variations with regard to materials and process steps are possible.

Nonlimiting examples of materials suitable for making shell of the microcapsule include urea-formaldehyde, melamine-formaldehyde, phenol-formaldehyde, gelatin, polyurethane, polyamides, cellulose esters including cellulose butyrate, acetate and cellulose nitrate, cellulse ethers like ethyl cellulose, polymethacrylates.

Other encapsulation techniques are disclosed in MICROENCAPSULATION: Methods and Industrial Applications Edited by Benita and Simon (Marcel Dekker, Inc. 1996).

A preferred method for forming shell capsules useful herein is polycondensation, typically to produce aminoplast encapsulates. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents in addition to formaldehyde (e.g. toluene diisocyanate, divinyl benzene, butane diol diacrylate etc.) may also be used and secondary wall polymers may also be used as appropriate, as described in the prior art e.g. anhydrides and their derivatives, particularly polymers and co-polymers of maleic anhydride as disclosed in W002/074430.

Preferred shell capsules for use in the present invention are aminoplast capsules and gelatin capsules. These microcapsules provide optimum performance in combination with the perfume composition of the present invention. Furthermore, these microcapsules also provide the best performance when used in combination with an aqueous cleaning composition and/or a cleaning implement as will be further described. During use, at least a portion of the microcapsules rupture thereby releasing the perfume composition. Aminoplast capsules are friable and crumble when abraded. Gelatin capsules furthermore dissolve, at least partially, upon contact with the aqueous cleaning composition, leading to leakage of the perfume composition.

The shell capsules typically have a mean diameter in the range 1 micrometer to 100 micrometers, preferably from 40 micrometers to 90 microns, even more preferably from 50 micrometers to 80 micrometers and most preferably between 60 micrometers to 70 micrometers. The particle size distribution can be narrow, broad or multimodal. Particle size is measured using typical light scattering methods employing instruments such as the Horiba LA-920 Particle Size Analyzer, the Malvern Mastersizer 2000, or Brookhaven's B1-XDC high resolution particle size analyzer.

The microcapsules can be dispersed throughout the cleaning substrate, but are preferably attached to the lower surface of the substrate (i.e. the surface which contacts the surface to be cleaned), or when the substrate is multi-layered, to the lower layer. This will enhance the rupturing of the microcapsule during use. Even more preferably, the microcapsules are placed in a location on the cleaning substrate where the microcapsules experience the greatest amount of pressure and/or abrasion during use. This is explained in more detail in copending U.S. patent application Ser. No. 60/685944 (P&G Case CM2971FP) “A Cleaning wipe comprising microcapsules, a kit and a method of use thereof”, (G. Jordan et al.), filed on May 31^{st}, 2005.

V. Cleaning Kit and Method of Use.

The cleaning wipes of the present invention can be used as stand-alone products, but preferably in combination with a cleaning implement, particularly for the cleaning of floor surfaces. Therefore, present invention also provides a cleaning kit for cleaning a surface comprising:
(a) a cleaning implement comprising a handle; and
(b) a cleaning wipe as previously described.
   Preferably, the kit further comprises an aqueous cleaning composition suitable for cleaning hard surfaces. Even more preferably, the kit comprises a delivery system capable of delivering the cleaning composition to the surface. In a highly preferred embodiment, the liquid delivery system is attached to the implement's handle, and comprises a container containing the cleaning composition. In use, the cleaning composition is first applied to the surface. The surface is then wiped with the cleaning wipe, attached to the cleaning implement.

Any cleaning composition typically used for cleaning hard surfaces may be used. Examples of cleaning compositions suitable for use in the present invention are described in WO 00/27271 (The Procter & Gamble Company). Typically, hard surface cleaning compositions also comprise a perfume composition. The perfume composition is preferably present at a level of 0.005% to 0.20%, by weight of the cleaning composition. However, because of the improved perfume release via microcapsules, the level of perfume composition in the cleaning composition can be lowered to less than 0.1%. It has also been surprisingly found that improved scent impression can be achieved when the perfume composition in the microcapsules is different in compositional ingredients than the perfume composition in the cleaning composition, i.e. both perfume compositions provide a different scent and have a different release profile.

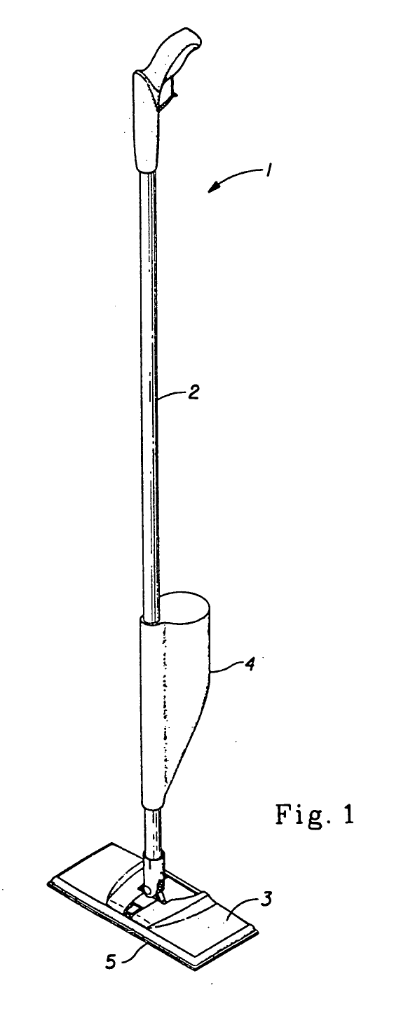

A preferred cleaning implement is shown in FIG. 1 and is marketed as Swiffer WetJet® by The Procter & Gamble Company. The cleaning implement (1) comprises a handle (2) which is attached to a mop head (3), via a pivotable joint. A liquid delivery system (4), containing an aqueous cleaning composition, is attached to the handle (2). As shown in FIG. 1, a cleaning wipe (5) is attached to the underside of the mop head (3).

VI. Examples

Preparation of Microcapsules onto Wipe

The following examples illustrate the preparation of cleaning wipes comprising perfume microcapsules:

Example 1—70 mg of polyoxymethylene urea microcapsules from Aveka, Inc. Woodbury, Minn. (containing 86%, by weight, of a perfume composition) are evenly distributed inside the cuff of a Swiffer WetJet® pad (marketed by the Procter & Gamble Company) using a cotton swab. The cuff can be opened up by gently peeling back the sides exposing the inside of the cuff. The cotton swab is found to be an effective way of controlling the amount and placement of the microcapsules with minimum capsule breakage. After adding the capsules the cuff is re-attached to the pad with adhesive or staples.

Example 2—A 6% aqueous solution of polyoxymethylene urea microcapsules is prepared using the perfume microcapsules described in Example 1. From this solution, 1.3 g is pipetted evenly along the cuff of a Swiffer WetJet® pad (marketed by the Procter & Gamble Company). The pad is allowed to dry overnight at room temperature.

Example 3—62.5 mg of polyoxymethylene urea microcapsules from Aveka, Inc. Woodbury, Minn. (80% perfume activity) are evenly distributed on one side of a Swiffer Dry™ sheet (marketed by the Procter & Gamble Company) using a cotton swab as described in Example 1.

Performance Evaluation Method

Test 1: The in-room odor evaluation is conducted in standard grading rooms of dimensions 7 ft (l)×9 ft (w)×9 ft (h) (2.134 m×2.743 m×2.743 m) on a vinyl floor covering. A Swiffer WetJet® pad is attached to the mop head of a Swiffer WetJet® implement. Comparative example A uses a normal, untreated cleaning pad (which is sold together with the Swiffer WetJet® kit). Example 1 is the cleaning pad with perfume microcapsules, as described above. The liquid product solution, which is sold together with the Swiffer WetJet® kit, is sprayed evenly across the vinyl floor for 12 seconds. The liquid product solution contains 0.06% of a perfume composition (which is different in composition as the encapsulated perfume composition). Starting towards the outer edge of one corner of the room, the floor is mopped in a back and forth motion until the entire floor surface has been wiped. To simulate a difficult to clean area, the product solution is sprayed in the center of the room for an additional 3 seconds and wiped back and forth 5 times over the sprayed area.

After mopping the room, the mop is removed from the room and the door to the room is shut. Expert graders enter the room at specific time points to grade the room according to the following odor intensity scale:
5=very strong, i.e., overpowering, permeates into nose, almost taste it
4=strong, i.e., very room filling, but not overpowering
3=moderate, i.e., room filling, character clearly recognizable
2=weak, i.e., can be smelled in all corners, still can recognize character
1=very weak, i.e., cannot smell in all parts of the room
0=no odor

Test 2: The in-room odor evaluation is conducted in standard grading rooms of dimensions 7 ft (l)×9 ft (w)×9 ft (h) (2.134 m×2.743 m×2.743 m) on a vinyl floor covering. A Swiffer Dry® sheet is attached to a Swiffer Dry® implement. Comparative example B uses a Swiffer Dry® Lemon scented sheet (as marketed by The Procter & Gamble company). A Swiffer Dry® Lemon scented sheet contains 5 mg of a perfume composition. Example 3 is a Swiffer Dry® cleaning sheet with perfume microcapsules as described above.

The floor is mopped in a back and forth method over the entire surface of the room. After mopping, the mop is removed from the room and the room odor intensity is graded at specific time points using the same grading scale as described above.

Performance Testing Results

The following data tables show the room odor benefits from using cleaning wipes according to the present invention.

| | Room Odor Grades | | |
|---|---|---|---|
| | 5 minutes after | 30 minutes after | 2 hours after |
| Treatment | application | application | application |

Test 1:

| | | | |
|---|---|---|---|
| Comparative | 3.0 | 2.5 | 0.5 |
| example A | | | |
| Example 1 | 3.5 | 3.5 | 2.0 |

Test 2:

| | | | |
|---|---|---|---|
| Comparative | 0 | 0 | 0 |
| example B | | | |
| Example 3 | 2.5 | 2.0 | 1.0 |

All documents cited in the Detailed Description of the Invention are, in relevant part, incorporated herein by reference; the citation of any document is not to be construed as an admission that it is prior art with respect to the present invention.” To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning wipe suitable for cleaning a surface comprising:
(a) a cleaning substrate; and
(b) microcapsules comprising a perfume composition;
wherein said perfume composition comprises perfume raw materials, and at least 40% of the perfume raw materials in said perfume composition have a boiling point of 250° C. or less, a Kovats Index value of 1450 or less, or combinations thereof.

2. A cleaning wipe according to claim 1, wherein at least 50% of the perfume raw materials in said perfume composition have a boiling point of 250° C. or less, a Kovats Index value of 1450 or less, or combinations thereof.

3. A cleaning wipe according to claim 1, wherein at least 40% of the perfume raw materials in said perfume composition have a boiling point from 100° C. to 250° C., a Kovats Index value from 900 to 1450, or combinations thereof.

4. A cleaning wipe according to claim 1, wherein said microcapsules have a shell comprising aminoplast, gelatin, or combinations thereof.

5. A cleaning wipe according to claim 1, wherein said microcapsules have a mean diameter of from 1 micrometer to 100 micrometer.

6. A cleaning wipe according to claim 1, wherein said microcapsules have a mean diameter of from 40 micrometer to 90 micrometer.

7. A cleaning wipe according to claim 1, wherein said cleaning wipe comprises from 10 mg to 500 mg of said perfume composition contained in said microcapsules.

8. A cleaning wipe according to claim 1, wherein said substrate comprises nonwoven fibers.

9. A cleaning kit suitable for cleaning a surface comprising:
(a) a cleaning implement comprising a handle; and
(b) a cleaning wipe according to claim 1.

10. A cleaning kit according to claim 9, wherein said cleaning kit further comprises an aqueous cleaning composition.

11. A cleaning kit according to claim 10, wherein said aqueous cleaning composition comprises from 0.005% to 0.20% of a perfume composition.

12. A cleaning kit according to claim 10, wherein said perfume composition in said microcapsules, and said perfume composition in said aqueous cleaning composition are different in compositional ingredients.

13. A method of cleaning a surface comprising the step of contacting said surface with a cleaning wipe according to claim 1.

14. A method of cleaning a surface according to claim 13, wherein said cleaning wipe is attached to a cleaning implement.

15. A method of cleaning a surface according to claim 14, wherein the cleaning implement comprises a system for delivering an aqueous cleaning composition, and wherein the method comprises the step of delivering said cleaning composition to said surface.

16. A method of cleaning a surface according to claim 13, wherein a citrus, lemon or floral scent is released from said microcapsules.

17. Microcapsules for use in a cleaning wipe, said microcapsules comprising a perfume composition, wherein said perfume composition comprises perfume raw materials, and at least 40% of the perfume raw materials in said perfume composition have a boiling point of 250° C. or less, a Kovats Index value of 1450 or less, or combinations thereof.

18. Microcapsules according to claim 17, wherein said microcapsules have a shell comprising aminoplast, gelatin, or combinations thereof.
